(19) United States
(12) Patent Application Publication
(10) Pub. No.: US 2017/0108852 A1
(43) Pub. Date: Apr. 20, 2017

(54) Middleware architecture for validating and controlling manufacturing processes

(71) Applicant: Juan Tirado, San Juan, PR (US)

(72) Inventor: Juan Tirado, San Juan, PR (US)

(21) Appl. No.: 14/885,855

(22) Filed: Oct. 16, 2015

(51) Int. Cl. G05B 19/418

(52) U.S. Cl. CPC G05B 19/4185; G05B 2219/32424

(57) ABSTRACT

The present invention comprises a cloud-based interface layer comprising a plurality of telegram structures, a plurality of telegrams based on the plurality of telegram structures, and a telegram processor that parses said plurality of telegrams. The interface layer acts as a middleware architecture between a plurality of systems providing standardized storage for all of them. The telegrams are used to validate and control the processes between these systems. The systems may include a manufacturing execution system, a quality management system, a learning management, and a laboratory information management system. The interface layer is designed to be prevalidated according to one or more industry standards such as the Good Manufacturing Practices (GMP).

### RELATED APPLICATIONS

This application claims the benefit of priority of provisional application 62/064,991 filed on Oct. 16, 2014.

### STATEMENT REGARDING FEDERALLY SPONSORED RESEARCH AND DEVELOPMENT

N/A

### BACKGROUND OF THE DISCLOSURE

Technical Field

The present invention relates generally to a computer-implemented method and system for controlling and validating a whole flow production process in pharmaceutical enterprises, namely manufacturing and quality assurance.

Discussion of the Background

Biotech and pharmaceutical systems have always been highly complex and expensive. Hardware and software requirements are daunting in scale, variety, and speed of obsolescence. They also require large teams of experts for installation, configuration, testing, operation, security, and maintenance.

When you scale this effort across dozens or sometimes hundreds of applications, it's easy to see why the largest companies with the best IT departments are not getting the systems they need. Small and mid-sized businesses do not stand a chance. The present disclosure is directed to overcoming the one or more problems or disadvantages associated with the prior art.

### SUMMARY OF THE DISCLOSURE

In accordance with one aspect, the present disclosure is directed to provide a centralized and fully digitized validation. The interface layer described herein allows digitized validation by providing technical means to assure that the processes are always performed according to a predetermined standard. The standard may be an industry standard such as the Good Manufacturing Practices (GMP).

According to another aspect, the present disclosure is directed to increasing computational efficiency that matches enterprise-scale infrastructure.

Another aspect of the present disclosure is directed to avoid software obsolescence risk.

According to another aspect, the present disclosure is directed to simplifying regulatory compliance effort by delivering validated solutions.

### BRIEF DESCRIPTION OF THE DRAWINGS

The accompanying drawings, which are incorporated herein, constitute part of the specifications and illustrate the preferred embodiment of the disclosure.

FIG. 1 shows an exemplary embodiment of the process flow for controlling a whole flow production process in pharmaceutical in accordance to the principles of the present invention;

FIG. 2 shows an exemplary embodiment of the design Landscape and Interface Layers in accordance to the principles of the present invention;

FIG. 3 is an exemplary embodiment of the interface communication of the present invention in accordance to the principles of the present invention;

FIG. 4 is an exemplary table of the material telegram structure in accordance to the principles of the present invention;

FIG. 5 is an exemplary table of the batch/lot telegram structure in accordance to the principles of the present invention;

FIG. 6 is an exemplary table of the telegram structure in accordance to the principles of the present invention;

FIG. 7 is an exemplary table of the telegram error when failing to include a defined segment and mandatory fields in accordance to the principles of the present invention;

FIG. 8 is an exemplary table of the non-conformance creation in accordance to the principles of the present invention;

FIG. 9 is an exemplary table of the training verification telegram structure in accordance to the principles of the present invention;

FIG. 10 is an exemplary embodiment of the BI architectural landscape in accordance to the principles of the present invention;

FIG. 11 is an exemplary embodiment of the graphical unit interface in accordance to the principles of the present invention.

### DETAILED DESCRIPTION

The embodiments of the invention disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

For purposes of this discussion, the term “module” may include at least one of software, firmware, and hardware (such as one or more circuits, microchips, or devices, or any combination thereof), and any combination thereof. In addition, it will be understood that each module may include one or more components within an actual device, and each component that forms a part of the described module can function either cooperatively or independently of any other component forming a part of the module. Conversely, multiple modules described herein may represent a single component within an actual device. Further, components within a module may be in a single device or distributed among multiple devices in a wired or wireless manner.

The present disclosure provides several words, including:

| Word/ | |
|---|---|
| Abbreviation | Definition |
| ERP | Enterprise Resource Planning which is a tool to define and |
| | manage resources needed to run business including |
| | materials management and inventory management |
| MES | Manufacturing Execution System. |
| QMS | Quality Management System. |
| LMS | Learning Management System. |
| LIMS | Laboratory Information Management System. |
| CCMS | Certification Candidate Management System |
| Message | Term used to describe the data communication for a |
| | specific type of data on a general basis. |
| | See “Telegram” |
| Telegram | Specific communication of data that denote the actual data |
| | structures communicated between the systems. |

In detail, the present disclosure is directed to a system that allows controlling and validation of the execution of tasks in a pharmaceutical environment. The system includes one or more processors. In a preferred embodiment, the system is cloud-based providing access to processing power in private or public cloud services. The invention may be implemented, for example, in Amazon AWS or Microsoft Azure. The invention may also be implemented in a private cloud infrastructure such as OpenStack or OpenNebula.

The system includes an access control module optionally providing single sign-on services. Single sign-on allows users to enter their credentials in only one authenticating system whereby generating an authentication session recognized by the independent modules of the present invention or by third party applications. For authentication, Form-based authentication mechanism may be used using a database to store user's details. Authentication and authorization maybe performed using services such as Microsoft Active Directory.

In terms of security, the system may also limit trusted user access to devices through the authentication of users, automatic timed user session log-offs appropriate for the use environment and using multi-factor authentication.

The system further includes a plurality of databases. In a preferred embodiment, the databases are SQL databases with XML data types. One example of such database is PostgreSQL. Other types of databases such as column-oriented databases, (i.e. Cassandra or Voldemort), or any other data structure storage (i.e. Redis) may be used to implement this invention.

In an embodiment, the data layer may use an object-oriented pattern to operate on database such as DAO. The DAO design pattern provides a technique for separating object persistence and data access logic from any particular persistence mechanism or API, making it ideal for a data access layer. The DAO approach provides flexibility to change an application's persistence mechanism over time without the need to re-engineer application logic that interacts with the data access layer. The applications may also use ODBC and JDBC connections to connect and retrieve data from the different databases in the system.

The databases may also implement a map where all fields are aggregated into key-value pairs. In an embodiment, the key is the name of the field from its definition. A generic entity may provide access for the map values and other useful methods. A generic entity may be the one and only data transfer object which is used to exchange data between data layer and service layer.

The interface layer provides mechanisms to execute procedures triggered by telegrams received in the system. In a preferred embodiment, the interface layer provides a remote procedure call (RPC) interface. The RPC interface may be implemented using XMLRPC or remote execution environments such as RabbitMQ. In another embodiment, the plurality of databases provide the RPC mechanisms.

The system may also provide a common storage where all data is serialized and standardized according to predetermined specifications. The standardized storage provides a single storage for data common to all of the modules and third party applications. For instance, the standardized storage may be designed to store SI Units. When data is requested from a system using a different unit (i.e. Imperial Units), the interface layer performs a remote call procedure call and converts the units accordingly before sending the data in a telegram. In a preferred embodiment, units of measure are communicated in their ISO code format (e.g. KGM, GRM, LTR, and PCE). A skilled artisan recognizes that the standardized storage may be a database in the plurality of databases or an independent structured storage.

The system also provides a telegram interface layer capable of communicating data between systems and validating the processes performed therein. The telegram interface layer comprises a plurality of telegram structures. These telegram structures are designed to be recognized as data structures providing flexibility and computational efficiency in terms of extracting and validating data. A telegram structure is a data type without any relevant information. This telegram interface layer may be regarded as a middleware architecture providing standardized access and storage between all the systems described herein.

The interface layer is responsible for providing one common interface to database access within data access layer. The interface layer may use particular data utilities for searching, sorting, paging, and similar. In another embodiment, the interface layer provides services to create and manage model and view definitions which are deployed in plugins. The interface layer is also responsible for all business logic which is provided by application.

The telegram interface layer is designed to generate and receive a plurality of telegrams based on the plurality of telegram structures. In an object-oriented embodiment, the interface layer creates a new instance of a telegram structure to generate a new telegram. The fields of the new telegram are then modified according to the data that is to be sent.

The telegram interface layer also includes a telegram processor parsing the plurality of telegrams according to the plurality of telegram structures. In one embodiment, the telegram processor may be a callback procedure that triggers execution whenever a telegram is sent. The telegram processor identifies the telegram structure and, as a security measure, checks whether the telegram conforms to a genuine message from a system. This is known in this specification as a plausibility check. After parsing the telegram, the telegram processor directs the message to the intended system and/or stores the data in the standardized storage.

A data transfer monitor module in the interface layer ensures that all non-trivial communications are performed without errors. The data transfer module validates data transfers by monitoring the transfer until completion. In an exemplary embodiment, the interface layer creates a new execution thread for each data transfer. Each execution thread contains a callback function that is executed when the data transfer results in an error. In another embodiment, each execution thread also contains a callback function executed when the data transfer is successful. The transfer of the data is subject to transaction monitoring. In case of an error in the transfer, the message gets an error status. The dialogs of the interface layer can be used to re-trigger the transfer of a faulty message.

The system also comprises an error handler module. Upon an error detection, the error handler module may notify a user or mark the telegram as an error. In a preferred embodiment, the telegrams that produced an error remain in the telegram interface layer when an error is recognized until the error is cleared.

The error handler module handles errors when the systems communicate directly or through the interface layer. In direct communication, the sender of a telegram makes sure that the telegram is placed securely into the interface layer. As a security measure, the sender's interface functionality executes a plausibility check for the communication leaving. In case of errors, the sender treats them internally and no data is sent. The receiver of a message processes the data independent of the sender. The receiver's interface functionality also carries out a plausibility check for the data communicated. In case of errors during input processing, the receiver treats them internally. There is no callback to the sender. No feedback telegram is sent to the sender.

When the results of plausibility checks the system shows discrepancies in the contents of telegrams in the input processing or are unable to send a telegram to the system, the telegram remains in the system interface layer. A corresponding error status indicates that an error was recognized. The user can choose between the two alternatives: retrigger the telegram processing or deleting the telegram. After the problem is eliminated input processing or communication to the system can be triggered again. The user can also delete the telegram. After it was deleted, however, the user must manually take care of appropriate data consistency in the system.

The design and interface processes of the present invention have an auto-restart function. So, when starting the computer or when a process fails automatic restart can be configured, when required. A loss of data is impossible as the telegrams not yet transferred to the present invention and the telegrams not yet entered are saved in a buffer storage.

The interface layer may also contain a reporting module capable of showing all relevant data in the system including usage, validation, data transfers and errors.

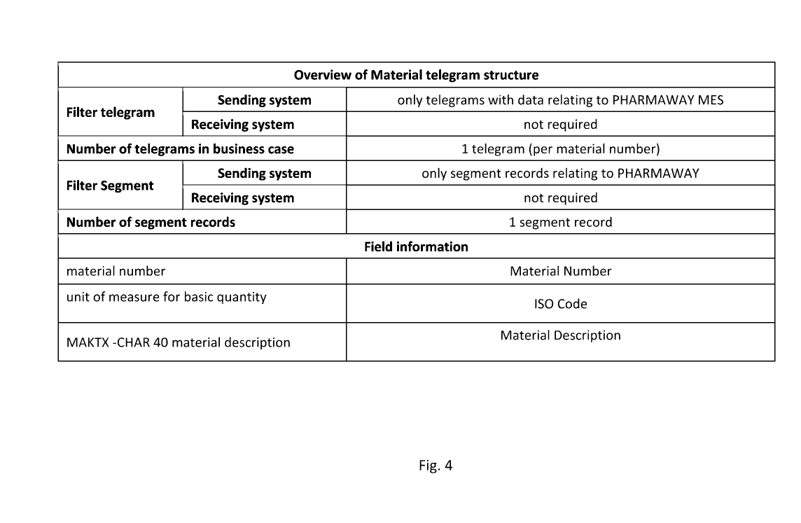

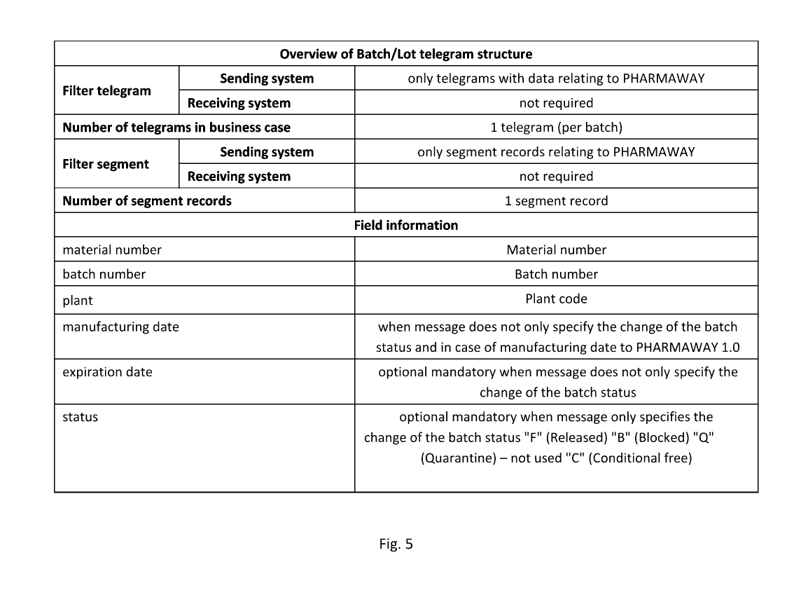

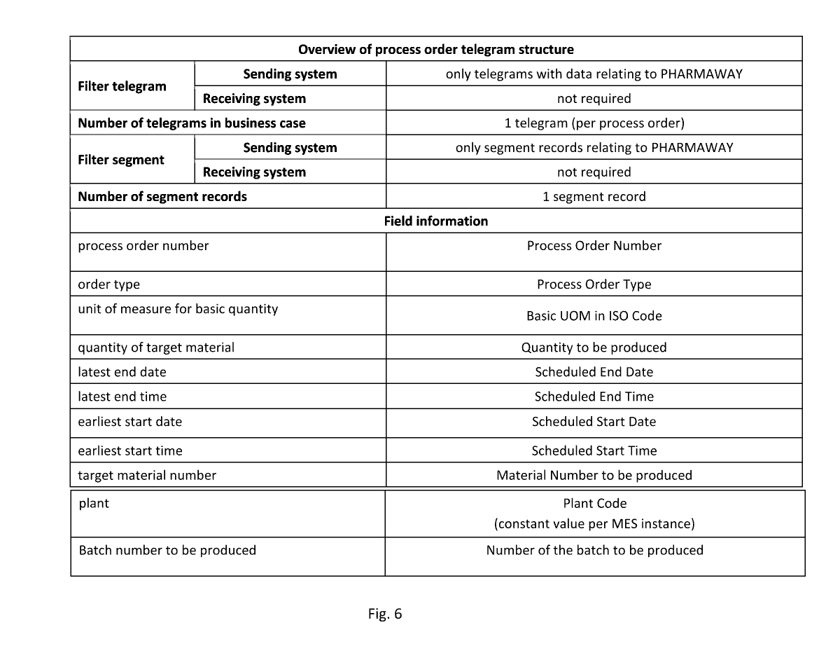

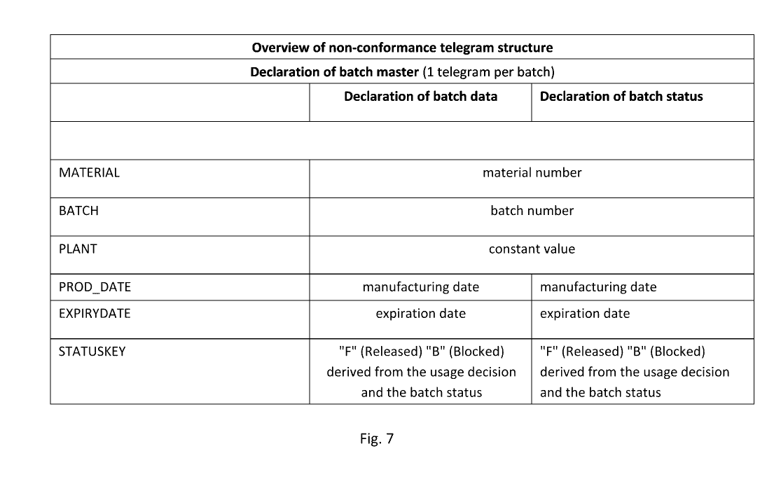

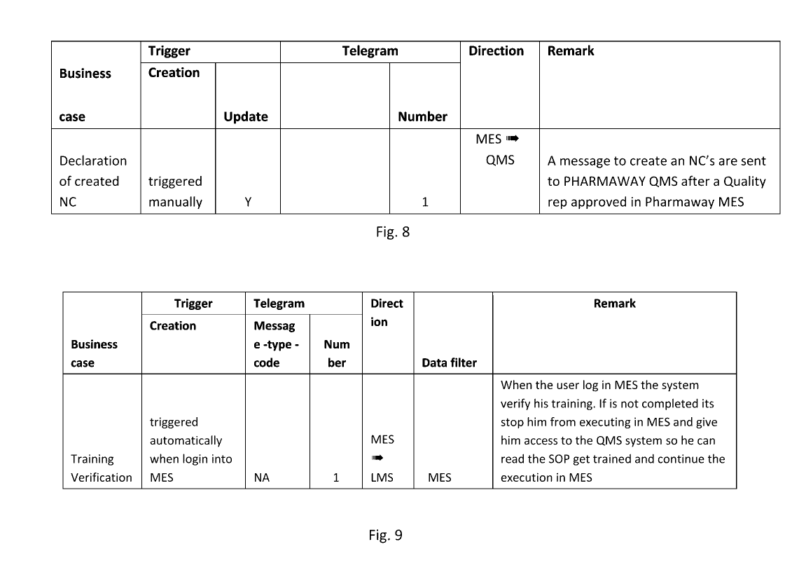

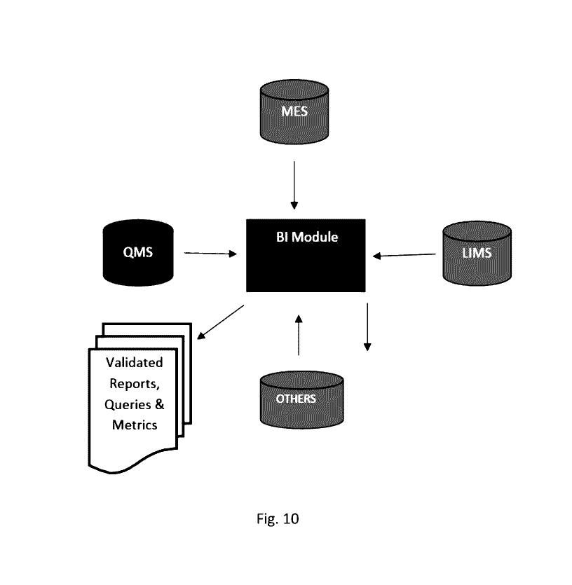

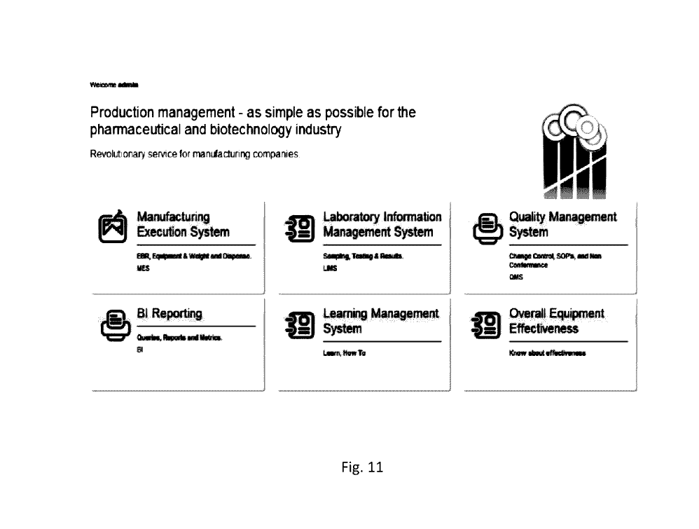

In a preferred embodiment, the telegram structures in the interface layer include: a material telegram structure (shown in FIG. 4) comprising a unit of measure and a material description; a batch/lot telegram structure (shown in FIG. 5) comprising a batch identifier, a batch status, and a plant identifier; a process order telegram structure (shown in FIG. 6) comprising a unit of measure and a quantity of target material; and a non-conformance telegram structure (shown in FIG. 7), wherein the non-conformance telegram structure includes information to update the corresponding batch data status. As shown in FIG. 8, all non-conformance telegrams are sent to the QMS for processing.

In another preferred embodiment, the telegram structures further include a user training verification telegram structure (not shown) comprising a user-access level, wherein communication in the system is generated only after certifying the user-access level. As shown in FIG. 9, certifying the user-access level is not an authentication procedure but rather refers to determining whether the user has the necessary certifications and/or credentials to perform the action that she wants to perform. For instance, if the user attempts to perform quality assurance but does not have the necessary training, the system generates a non-conformance record and does not permit the user to continue with the quality assurance.

In a preferred embodiment, the interface layer may also generate a corrective and preventive action record. In the example above, the interface layer may cause the LMS to provide the user with the necessary training on the site. In that way, the user can receive the training through the computer and, after the training is done, the non-conformance record is cleared and the user is allowed to perform the action previously denied.

The system also provides a method for managing applications for the completion of a manufacturing process comprising receiving a work order and receiving a material requirement, assembling a work order bill of materials, and generating an electronic batch record. The system monitors application users' learning information, certifies the application users' training record data, and allows access to a manufacturing execution system and a quality management system only after certifying application users' training record. The system further receives the application users' quality inspection information and generates a non-conformance record only after receiving a negative quality inspection result. A non-conformance record causes the batch/lot to be placed on hold in the quality management system.

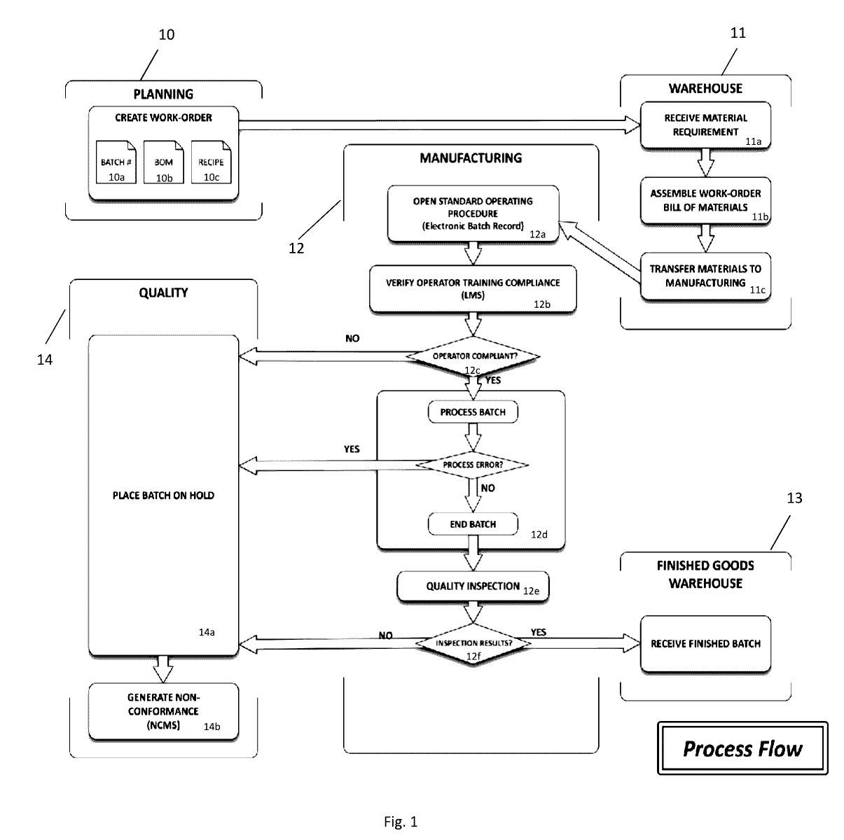

Referring to FIG. 1, the present invention, in particular the interface layer, handles the process flow of a pharmaceutical process. An exemplary embodiment of the interface layer includes handling of the various phases of the process flow. In the planning phase 10, the system generates a work-order 10a including a batch data 10b. The work-order 10a is then transferred, as a telegram, to the system handling the warehouse phase 11. In the warehouse planning phase 11, the system receives a material requirement 11a, assembles the bill of materials 11b ensuring that the materials are available according to the storage, and transfers the materials to manufacturing 11c.

In the manufacturing phase 12, a standard operating procedure is opened (12a) by identifying the corresponding procedure according to the work-order 10a. The system then verifies the operator training compliance (12b) by querying the LMS. If the operator is compliant (12c), the system allows the operator process the batch (12d). When the batch is done, a quality inspection is performed (12e) and the batch is handled according to the inspection results (12f). If the result is positive, the batch is sent to the finished goods warehouse phase 13.

However, if the operator is not compliant (12c), if there are errors in the batch processing (12d), or if the inspection results are negative (120, the batch is transferred to the quality phase 14 where the batch is placed on hold (14a) and a non-conformance record is generated (14b).

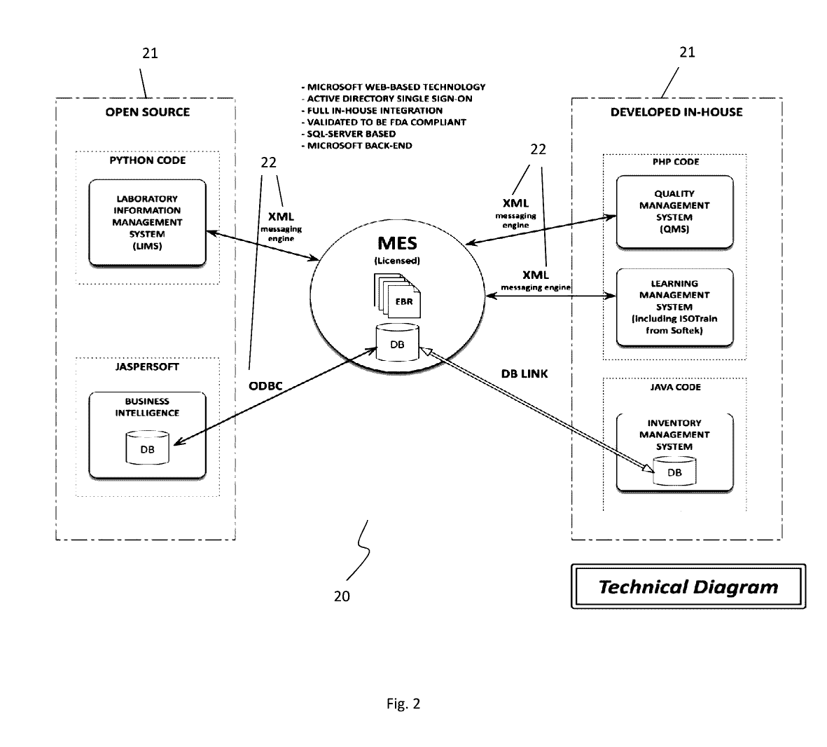

In an embodiment, the present invention method and system covers the system design and interfaces between MES and the other modules in the package including ERP, LIMS, CCMS (certification candidate management system), and Reporting. As shown in FIG. 2, the infrastructure and interface communication is made in two layers: the interface for direct communication 21 and an interface layer that provides data to the application in standardized form or collects data from the application 22.

The present invention, more particularly the infrastructure landscape 20, may use web-based and cloud-based servers and single sign on security. For instance, an exemplary embodiment may be implemented in Microsoft Azure cloud servers and Active Directory/Single Sign-On. The source code may be implemented in any programming language capable of handling HTTPS and SQL/XMLDB calls. An exemplary development framework uses JAVA programming framework and Oracle XML DB together with ODBC and HTTPS to handle, create, manage the system and transfer XML files according to the SOAP standard. An appropriate adapter (SOAP adapter) is part of the XML ENGINE standard system. One interface process is employed for each communication direction 21,22.

As shown in FIG. 11, a web browser responsible for all client side operations in a cloud-based environment. In a preferred embodiment, the initial validation, simple logic between elements of the view, and some simple logic responsible for handling communication with the server may be executed on the web browser. The client side logic may be developed using libraries such as JQuery.

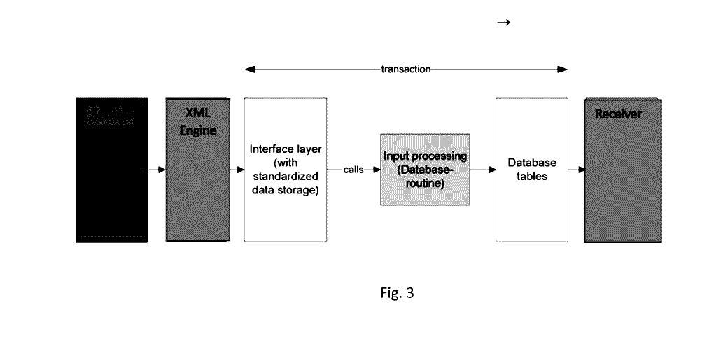

As shown in FIG. 3, the input processing may consist of remote procedure calls, such as MYSQL and XML routines, which read the data from the interface layer and make it available to the rest of the components. This can be done, for example, by storing the data in database tables or by transfer to the application's function modules (i.e. MYSQL routines). A background process of the present invention interface layer may call the MYSQL routines. The routines also set the status of the data to be processed in the standardized storage system of the interface layer, thus enabling the subsequent archiving of this data. It is well-known in the art that processing and storing data by way of remote procedure calls outside of database routines. As shown in FIG. 4, the present invention uses predefined data formats to process telegrams efficiently. Changes made on the number range objects in the system affects the interface. When number ranges are put into the interface layer that differ from the agreed data element lengths, errors will occur since it is no longer possible to communicate and process the data properly.

All telegrams are communicated between single components of the system modules only once. When it is necessary to forward the data inside the receiving system, the transfer is made as a system internal transfer only. Thus, the telegrams include no reference to previous operations/documents if not necessary.

There are no acknowledgements within the scope of data communication. This means that manual acknowledgements, for example, to confirm withdrawals or in other cases, are not made or do not lead to callback telegrams or further telegram communication.

In all telegrams, the quantity indications refer to the quantity actually handled. Exceptions are mentioned separately. The basic quantity unit is used to administer stocks and indications of quantity values in the EBR.

The telegram structures stated on the pages below do not include all the fields, but are restricted to the relevant environment. The telegram structures serve to illustrate the fields that are processed/provided in the message.

Outbound messages from each module instance are identified by a Transmission Number. The transmission number is generated in sequential fashion and stored in each message header.

The interface uses a number of telegram structures to handle the communication for relevant business cases. The various telegram structures are used for the different business cases. The telegram structures are designed from the application's point of view and only the data relevant for the receiving system's application is stated. Thus, telegram structures may comprise additional information not explicitly mentioned here.

Telegrams are used to divide the business case data (messages). The number of telegrams and the data structures (segments) used in the Telegram are defined by the business case. Fields are used to define the actual value for the objects used in the business case. The stated basic type is set according to the system specifications. All telegram structures contain the following identifications: (1) telegram information, (2) segment information, (3) field information, and (4) filters.

The telegram information includes the number of telegrams in the business case. This information states whether there is more than one user data record in each telegram. Likewise, the segment information includes number of data. This information states whether there is more than one user data record in the segment.

Filters state whether there is a filter set in the sending system on telegram level and whether the receiving system needs a filter set on data level. Segment information states whether there is a filter set in the sending system on segment level and whether the receiving system needs a filter set on data level because there are irrelevant segment records.

In terms of materials data, all relevant materials are known in MES, the modules and third party applications alike. Material master data sent by MES is not changed in the modules of the packages or the third party applications. The material master data is transferred to the modules when changes are made on the data. Material master data is not transferred in lists, but each material master data record creates a telegram of its own.

Material master telegrams are generated by the MES. When sending a new material master data record, the MES assures that all data relevant was maintained. The MES does not send a newly created material master data record unless the fields relevant are present. When material master data is changed, all segments are transferred, not only the ones that were changed. When material is maintained in several plants, only the data for the relevant plant is adopted.

The material master telegrams are generated by cyclical batch run or by manual triggering when one of the transferred data fields is changed, or the deletion flag is set.

When the telegrams are received by the interface layer, they get a corresponding error status if they do not contain the defined segments and mandatory fields. When a material master data record is newly created, all data records are created in all tables by the interface layer. If no values are provided in the telegrams, the default values will be used for the field contents to be added. After the material master telegram is received the interface layer creates the batch status in MES and sends batch data and batch status in one message.

When a new batch is created, the batch status or batch data is changed a message is sent to the other modules and third party systems. Batch data changes are not transmitted to the MES unless the data changed is relevant. Based on the received data, the batch status and batch data are either created or updated by the interface layer. If there are no stock of materials in the system the batch data is still loaded into the database. When the messages transferred by the interface layer fail to include the defined segments and mandatory fields, they get a corresponding error status.

Errors and other deviations on the produced batch upon the execution of the Process Orders or EBR's trigger the creation of non-conformance records. Non-conformance records may be generated upon an error found in the interface layer or in any of the third party applications. In an exemplary embodiment, a quality associate needs to approve the creation of the NC in the QMS.

All non-conformance records are sent to the QMS. Upon receipt of the message, the QMS generates a non-conformance record. The update itself will trigger the interface layer to update the batch data record. Errors relating to manufacture and/or compliance are triggered in the MES and generated in the QMS. In an exemplary embodiment, a quality associate need to approve the creation of the NC from MES via an icon or button. In an exemplary embodiment, upon receipt of the message, the QMS handles the non-conformance and Corrective and Preventive Action (CAPA) workflow.

The LMS includes all the associates training records. Upon confirmation of a user entering the system, the LMS retrieves the user training record data (based on the user training verification telegram structure) and allows the user to execute actions in the MES only after certifying that the user-access level is sufficient. The LMS certifies the associate by obtaining the associate's training records and verifying that the associate has the necessary training according to the predetermined rules in the system. In an exemplary embodiment, the predetermined rules correlate to one or more industry standards such as the Good Manufacturing Practices (GMP).

The user training record data either approves or rejects the user execution in PHARMAWAY MES. All the modules data will be available via the Reporting module to create reports, queries and metrics.

Telegrams in MES, LMS LIMS and QMS are triggered to be sent on completion of operation (posting).

In a preferred embodiment, the present invention has a modular architecture where every business functionality can be added to application with new plugin. This extensibility and configurability may be achieved using frameworks such as Spring, Plone, Jaspersoft and/or Alfresco.

The system may also include modules to perform documentation management; verification; product & service specifications; performance assurance; and, safety, security and privacy protection by providing internal audits of vulnerabilities according to industry standards.

I claim:

1. A system for controlling and validating the execution of tasks in a pharmaceutical environment comprising:
a processor;
a network interface;
a memory comprising:
an access control module;
a plurality of databases,
a remote procedure call module,
a standardized storage, and
a telegram interface layer comprising:
a plurality of telegram structures,
a plurality of telegrams based on the plurality of telegram structures,
a telegram processor parsing the plurality of telegrams according to the plurality of telegram structures,
a data transfer monitor module,
a reporting module, and
an error handler module, wherein the plurality of telegrams that triggered an error remain in the telegram interface layer until the error is cleared.

2. The system of claim 1, wherein the plurality of telegram structures comprises a material telegram structure comprising a unit of measure and a material description.

3. The system of claim 1, wherein the plurality of telegram structures comprises a process order telegram structure comprising a unit of measure and a quantity of target material.

4. The system of claim 1, wherein the plurality of telegram structures comprises a batch/lot telegram structure comprising a batch identifier, a batch status, and a plant identifier.

5. The system of claim 5, wherein the plurality of telegram structures comprises a non-conformance telegram structure, wherein a non-conformance telegram based on the non-conformance telegram structure causes a batch/lot to be placed on hold.

6. The system of claim 2, 3, 4 or 5, wherein the plurality of telegram structures comprises a user training verification telegram structure comprising a user-access level, wherein the plurality of telegrams is generated only after certifying the user-access level.

7. The system of claim 1, wherein the access control module is a single sign-on security mechanism.

8. The system of claim 1, wherein the telegram interface layer validates the execution of tasks according to a ruleset in the remote procedure call module.

9. The system of claim 1, wherein the plurality of telegram structures are prevalidated according to a manufacturing standard.

10. A prepackaged and prevalidated application management and execution system comprising:
a manufacturing execution system;
a quality management system;
a laboratory information management system;
a learning management system;
an enterprise resource planning system;
a reporting system; and
a middleware architecture comprising:
a plurality of telegram structures,
a plurality of telegrams,
a telegram processor parsing the plurality of telegrams according to the plurality of telegram structures,
a data transfer monitor module, and
an error handler module,
wherein said middleware architecture provides data to said systems in standardized form.

11. The system of claim 10, wherein the plurality of telegram structures comprises a material telegram structure comprising a unit of measure and a material description.

12. The system of claim 10, wherein the plurality of telegram structures comprises a process order telegram structure comprising a unit of measure and a quantity of target material.

13. The system of claim 10, wherein the plurality of telegram structures comprises a batch/lot telegram structure comprising a batch identifier, a batch status, and a plant identifier.

14. The system of claim 13, wherein the plurality of telegram structures comprises a non-conformance telegram structure, wherein a non-conformance telegram based on the non-conformance telegram structure causes a batch/lot to be placed on hold.

15. The system of claim 11, 12, 13 or 14, wherein the plurality of telegram structures comprises a user training verification telegram structure comprising a user-access level, wherein the plurality of telegrams is generated only after certifying the user-access level.

16. An application management and execution method comprising the steps of:
managing applications for the completion of a manufacturing process comprising receiving a work order and receiving a material requirement, assembling a work order bill of materials, and generating an electronic batch record;
monitoring application users' learning information, certifying application users' training record data, and allowing access to a manufacturing execution system and a quality management system only after certifying application users' training record;
receiving application users' quality inspection information and generating a non-conformance record only after receiving a negative quality inspection result.
